(19) United States
(12) Patent Application Publication
(10) Pub. No.: US 2003/0084107 A1
(43) Pub. Date: May 1, 2003

(54) Remotely programmable verifiable intelligent message display system and method of operation

(76) Inventor: Larry G. Covey, Tampa, FL (US)

Correspondence Address: LARSON AND LARSON, 11199 69TH STREET NORTH, LARGO, FL, 33773

(21) Appl. No.: 10/000,118

(22) Filed: Oct. 31, 2001

(51) Int. Cl. G06F 15/16

(52) U.S. Cl. 709/206; 709/218

(57) ABSTRACT

A system for remotely programming electronic message display signs is provided. The system includes a host computer server having a plurality of software programs including an information database and dynamic content web page. Customers of the host log onto the web page through the Internet and create, edit and delete messages in which the customer wishes to show on the display units. The created messages are delivered to uniquely assigned e-mail boxes of which are contacted by a controller on a particular display unit. The messages are retrieved by the controller along with playlists an schedules which contain all of the data necessary to illustrate the display unit. Customers are permitted to configure the display unit parameters by creating a configuration file on the web page. The configuration file is also delivered to a uniquely assigned e-mail box which is contacted by the display unit controller. Each time the display unit controller address the message e-mail box, it leaves a log and status report which is delivered to the customer to verify that the content that they wishes to have displayed actually was displayed and at the proper time and duration.

### BACKGROUND OF THE INVENTION

1. Field of the Invention

This invention relates to an intelligent message display system. More particularly, it relates to a system for remotely programming intelligent message display apparatuses through the use of the Internet and a server based web site and database, wherein the customer is notified that the message was displayed as programmed and configured by the customer.

2. Description of Prior Art

Information display (i.e., messaging) systems are known in the prior art. One such system can be seen in U.S. Pat. No. 5,844,181 to Amo et al. wherein a series of display apparatuses are controlled via a central controller. Each display apparatus is uniquely addressable and is connected to the central controller by some form of communication protocol. The system permits the display apparatuses to be programmed at the central controller wherein the messages are then sent for display at a given time. Although the system is able to program a plurality of display signs, the system lacks a verification protocol which enables the customer to confirm that the message intended for a particular display sign was actually displayed and at the desired predetermined time. This is an inherent deficiency in the prior art which needs improvement.

The actual programming (configuring) of intelligent messaging systems has long been problematic and represent another inherent deficiency in known prior art intelligent messaging systems. It is understood that “intelligent messaging systems” are display systems which display a message through some type of light producing element, such as, for example LED messaging sign boards. Of course, other type of lighting apparatuses can employed. Messages can scroll, flash or be displayed in a variety of different manners known in the sign display art. Programming a display apparatus requires that the programmer use great care in loading the proper message to be displayed so that an errant message is not displayed on a specific display unit or a correct message displayed on a wrong display unit. Permitting customers to have access to uniquely addressable display signs would be considered an improvement in the art.

If the message display sign is located in a remote location from the programmer (i.e., in a different city), it becomes even more difficult to determine whether the message was actually displayed and is considered yet another inherent disadvantage in the prior art. Without a means for verification, it is difficult to know whether the proper message was displayed and if so, at what time it was displayed. To alleviate these problems, some form of two-way communication with the display unit is needed.

Some systems have attempted to form a two-way communication between a messaging system and a central location, such as that seen in U.S. Pat. No. 5,642,484 to Harrison, III et al. In this system, return information can be sent back to a central location relating to customer exposure to a set of given information (i.e., advertisement). This return information is sent back in response to interaction by the customer to the information (advertisement) that they are exposed to. The return information can be used to establish future demographic advertisement and the actual effectiveness of the advertisement. The return information in this system, or any other known prior art system, is not used by the customer to confirm that the message was actually displayed and at what precise time and duration. Instead, it is used to gather profile data about the person who interacted with the message displayed.

Other inherent disadvantages in the prior art that exist include the inability to permit the customer who wishes to have content displayed, the flexibility to program and configure the messaging display sign at their convenience. By introducing a programmer affiliated with the display units (the Host) an added level of interference is introduced. This is clearly not needed and only leads to potential error caused by the Host. What is needed is a system which permits customers to have access to one or more display signs regardless of their location. The customer can then program the content to be displayed at will and decide how long the content will run and at what time. Further, a report verification protocol is needed so that the customer can be notified that their message content was actually displayed for a given duration and at the desired predetermined time. By using the Internet and e-mail, the programming and report verification could be carried out effectively and quickly and would alleviate the need for a third party to be involved with display unit configuration, content programming and customer report verification.

### SUMMARY OF THE INVENTION

I have invented an intelligent message display system having a two-way communication protocol. My system, in its preferred embodiment, is used with LED messaging sign display units, although other types of illuminated displays can be employed. Communication with the display units is effected by a customer through the use of the Internet and can be established by any of the various known communication protocols, including, but not limited to, wired or wireless modems or satellite signals. A controller, mounted on each uniquely addressable display unit, returns verification data to the customer in the form of reports. The return verification data contains information regarding the content displayed on the sign, the time and date that the content was displayed and other pertinent information relating to any potential problems with the display unit.

The content to be shown on the display unit (the message or advertisement), the playlists and the schedules are all created and entered by the customer via a PC connection to the Host server web site through the Internet. The customer logs onto the web site through the Internet. Access to a database is granted to verified customers once they have logged onto the Host web site. The database displays information which allows the customer to choose the content of the message, the amount of frames to display (duration of the message), which playlists to run and in what order (if more than one message is programmed) and scheduling of the message or messages (or in other words, what time they should run). Once the customer has logged onto the database, new messages can be created, or previously created messages can be accessed and updated or merely retrieved for “broadcast” (i.e., display). The customer may also select a display type, display location, or a group of display units to which to send the content information.

Once all of the aforementioned configured customer information is entered into the Host web site database, it is sent to a server database maintained by the Host. The configured information is retrieved by a separate server program wherein the information is formatted and sent to a uniquely addressed e-mail box (or boxes if programming more than one display unit). The formatted information remains there until it is automatically retrieved by the display unit at a predetermined time through the use of the display unit controller.

Using a connection through the Internet, the display unit controller calls its assigned e-mail box at a pre-scheduled time and checks to see if any new messages have been deposited for collection therefrom (also known as the “call-home time”). If no new messages exist, the controller disconnects from its associated e-mail box and leaves a report log of what it previously displayed with the start and stop times in a central log and status e-mail box for later delivery to the customer. It also leaves a status report of any problems or other events of importance. If no new content was retrieved, then the controller fully disconnects from the Host server and the display unit continues displaying the existing schedule of advertisements (content) previously retrieved according to the previously retrieved playlists and schedules.

If new content was retrieved from its associated e-mail box, it replaces the existing content. Once the new content is validated, it will remain in the associated e-mail box in case of a problem so that the display unit controller can re-retrieve it if necessary. After retrieving new content, the controller disconnects from its associated e-mail box and leaves a report in the central log and status e-mail box for later delivery to the customer. Thereafter, the controller fully disconnects from the Host server and the display unit operates independently thereby displaying the retrieved customer configured content.

Periodically, such as, for example, once a day, a status-handling software program on the Host server will address the log and status e-mail box and retrieve all of the reports logged therein by all of the controllers of each display unit in the system. This status-handling software program will sort all of the gathered information and create a separate report for each customer. Each customer report contains data relating to the content displayed on each and every display unit assigned to each respective customer and the start and stop times of the displayed content. Further, the report includes information relating to any problems that may have occurred with any of the display units, such as, for example, power outages. If the report does not contain data relative to a specific display unit that should have been included, a special message is sent to the customer which “flags” the display unit and its location so that any necessary and required repair action can be implemented. The reports can be sent to the customers in a variety of manners, including, but not limited to, by e-mail, on a diskette, on a CD ROM, by facsimile or by regular or courier-based mail service.

The display unit controller is configured to operate in a certain manner in accordance with a configuration file that is retrieved from the Host server. Each display unit controller has its own configuration file. The file contains the protocol for the “call-home time”, the address of its unique associated e-mail box, connection instructions for logging into the log and status e-mail box, whether the display unit should run in interval or ad mode, when the unit should dim or when it should brighten, what the normal brightness level should be, when and when not to display its content and if the display unit has a temperature probe. All of these settings for the configuration file for each display unit are set up by the customer in the database on the Host server web site. Each display unit controller is programmed to obtain its configuration file by “calling-in” (connecting through the Internet) if it does not have a configuration file or if it loses its configuration file or if the display unit is commanded to do so by the customer or Host.

As set forth above, the display unit can run in either “interval mode” or “ad mode”. “Interval mode” is a system of operation wherein the display is constantly calling-in for updates, such as, for example, sport scores every fifteen minutes or stock quotes every minute. “Ad mode” on the other hand is the more common operational mode for the system of the present invention wherein the display is calling-in periodically to retrieve new customer programmed content, such as once a day.

As noted above, the display unit can also contain a temperature probe. The probe can periodically take the temperature of the ambient air around the display unit and display the temperature in text from thereupon.

### BRIEF DESCRIPTION OF THE DRAWINGS

The invention may be best understood by those having ordinary skill in the art by reference to the following detailed description when considered in conjunction with the accompanying drawings in which:

FIG. 1 is a first of two parts to a flow diagram depicting an overview of the Intelligent Messaging System of the present invention;

FIG. 2 is the second of two parts to a flow diagram depicting an overview of the Intelligent Messaging System of the present invention;

FIG. 3 is a flow diagram of the Intelligent Messaging System of the present invention illustrating how a multiplicity of display signs, a plurality of customer PCs, a Host server and various e-mail boxes all utilized within the System of the present invention can be located in a plurality of different locations but connected by the Internet;

FIG. 4 is a flow diagram illustrating how an individual display sign and its respective controller employed in the Intelligent Messaging System of the present invention are connected to one another and to the Internet;

FIG. 5 is a flow diagram illustrating how a customer, utilizing a PC, interfaces with the Host server through the Internet to program content for display on a display unit employed in the Intelligent Messaging System of the present invention;

FIG. 6 is a first of three parts to a flow diagram depicting the operation of a display unit and its associated controller utilized in the Intelligent Messaging System of the present invention and how it retrieves its content for display upon the display unit;

FIG. 7 is the second of three parts to a flow diagram depicting the operation of a display unit and its associated controller utilized in the Intelligent Messaging System of the present invention and how it retrieves its content for display upon the display unit;

FIG. 8 is the third of three parts to a flow diagram depicting the operation of a display unit its associated controller utilized in the Intelligent Messaging System of the present invention and how it retrieves its content for display upon the display unit

### DETAILED DESCRIPTION OF THE INVENTION

Throughout the following detailed description, the same reference numerals refer to the same elements in all figures.

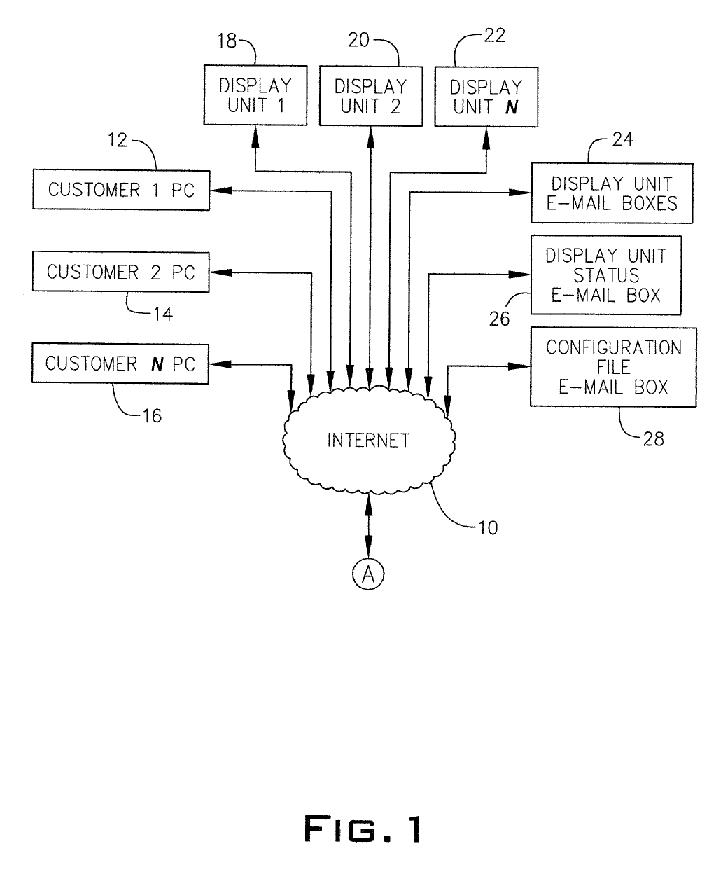

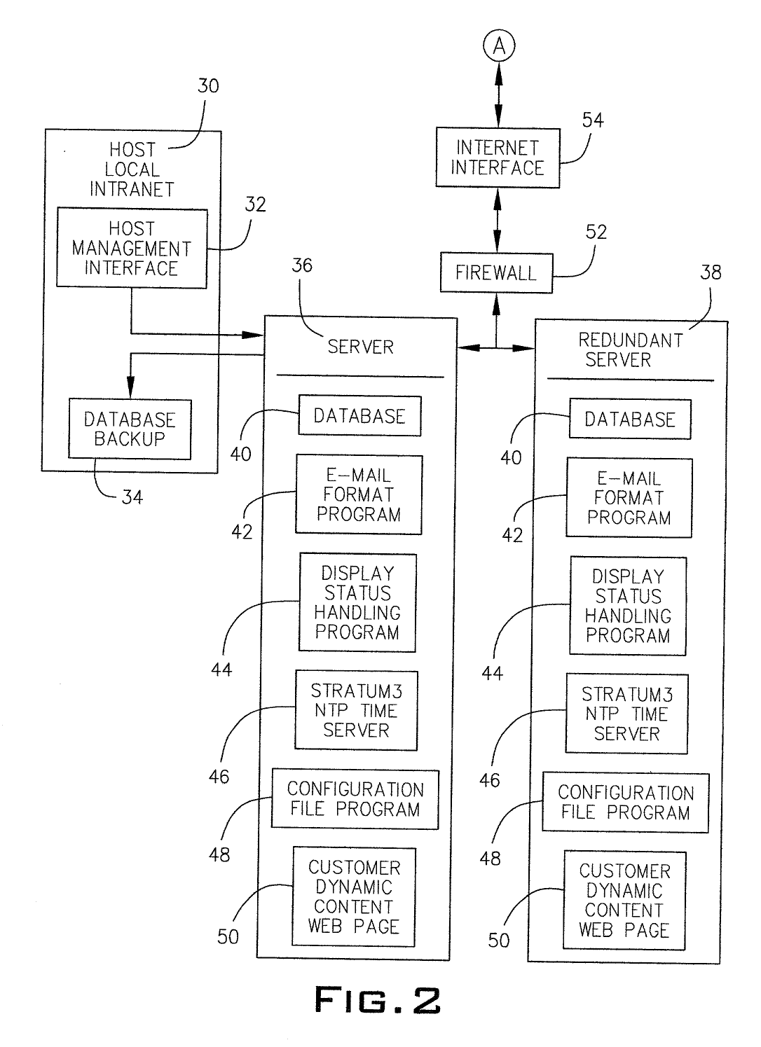

Referring to FIGS. 1 and 2, a flow diagram is shown illustrating an overview of the intelligent messaging system of the present invention. In particular, many of the elements of system are shown illustrating how they interact with each other by a two-way connection through the Internet 10. It is understood that the FIG. 1 connects directly to FIG. 2 by following the encircled capital letter A near the bottom of FIG. 1 which then again appears on the top of FIG. 2.

With continuing reference to FIG. 1, it is shown that a plurality of customers can utilize the intelligent messaging system by connecting to the Internet 10 with a PC (personal computer) or like computing device. The customer PC connection is a two-way connection. As shown in FIG. 1, the numeral 12 designates Customer PC 1, the numeral 14 designates Customer PC 2 and the numeral 16 designates Customer PC N, wherein N represents an infinite number of Customer PCs. As will be later discussed, there is no requirement that any of the Customer PCs be in the same location (i.e., in the same city, town or other locale). In fact, so long as the connection is made through the Internet 10, the Customer PC can be located anywhere in the world which provides an interface to the Internet.

Again, with continuing reference to FIG. 1, it is shown that numeral 18 designates Display Unit 1, numeral 20 designates Display Unit 2 and numeral 22 designates Display Unit N, wherein N represents an infinite number of Display Units. And, as with the Customer PCs, there is no requirement that any of the Display Units be in the same location. Each Display Unit is provided with a unique addressable ID number, such as, for example, an IP address, which delineates each Display Unit from each and every other Display Unit within the Intelligent Messaging System of the present invention.

Yet again, with continuing reference to FIG. 1, it is shown that numeral 24 designates a plurality of Display Unit E-Mail Boxes, numeral 26 designates a plurality of Display Unit Status E-Mail Boxes and numeral 28 designates a plurality of Configuration File E-Mail Boxes.

With reference now to FIG. 2, it is shown that a Host Local Intranet 30 is provided which can be located anywhere. Host Local Intranet 30 includes a Host Management Interface 32 and a Database Backup 34. Database Backup 34 can be any type of known backup medium, including, but not limited to, tape, CD-ROM or hard diskette. The Host Local Intranet is connected to a computer Server 36 which in turn is connected to a computer Redundant Server 38. Nothing herein limits the number of Redundant Servers that can be employed, however in the preferred embodiment, one Redundant Server 38 is employed.

With continuing reference to FIG. 2, it is shown that Server 36 and Redundant Server 38 contain a plurality of programs which assist in the operation of the Intelligent Messaging System of the present invention. As shown, they include a Database Program 40, an E-mail Formatting Program 42, a Display Unit Status Handling Program 44, a Stratum3 NTP Time Server 46, a Configuration File Program 48 and a Customer Dynamic Content Web Page 50. Both Server 36 and Redundant Server 38 are connected to a Firewall 52 which in turn is connected to an Internet Interface 54 which in turn is connected to the Internet 10 (shown in FIG. 1).

With reference now back to FIG. 1, Display Units 18, 20 and 22 are, in the preferred embodiment, LED (light emitting diode) display sign boards. However, nothing herein limits the use of other type of light emitting displays. In the LED embodiment, they can be single color (thereby utilizing any available colored LED bulb), multi-color (for example, red and green) or full color (for example, red, green and blue). The Display Units are capable of producing text or graphics. Each Display Unit is associated with a unique Configuration File E-Mail Box from the plurality of Boxes 28. A Display Controller, to be discussed in further detail hereinafter, is able to “call” its associated unique Configuration E-Mail Box and retrieve operating instructions (its configuration file). The configuration file contains all the information needed for the Display Unit to operate, such as, when to call-in to retrieve new content messages for display upon the Display Unit, to which Display Unit E-Mail Box from the plurality of Boxes 24 it should contact, and to which Display Unit Status E-mail Box from the plurality of Boxes 26 it should leave the Display Unit status and logs of what it has displayed for the last period. The Display Controller can operate over a CDMA wireless modem, wired modem or CDPD wireless modem. The Display Controller will call its assigned Display Unit E-Mail Box for messages at a predetermined customer defined time. When calling, the Display Controller will check for new frames (messages), playlists and schedules. The frames contain the messages, text or graphics to be played on the Display Unit. The playlists contain the list of message frames to be played, the order in which to play them and the length of each play for each message frame. The schedules contain the start and stop times for each playlist or series of playlists. The Display Controller maintains a record of each playlist and schedule it ran as well as the start and stop time of each playlist. This record forms a portion of a status message left in the appropriate Display Unit Status E-Mail Box from the plurality of Boxes 26 each time the Display Controller calls into the ISP (Internet Service Provider) hosting E-mail Boxes 24, 26 and 28.

Each customer is able to access the Customer Dynamic Web Page 50 by logging on to Server 36 through the Internet 10. When the Web Page 50 first opens, it requests a customer name and password previously established when the customer becomes a client of the Host of the Intelligent Messaging System. After this information is entered, the Web Page 50 checks the validity of the inputted customer information. If correct, a next page is displayed on the Customer PC which permits the customer to select a Display Unit type, Display Unit location or group of Display Units. After these selections are made, a main menu is displayed on the Customer PC permitting the customer to create, edit and/or delete message frames. Additionally, colors, text and number of lines can be changed. As to playlists, access is given to the customer to change dwell times (time for each message frame to play) as well as the order of play. Schedules can also be created and/or edited allowing the customer to set the start and stop times and the order in which to run the playlists. A send command selects which Display Unit or group of Display Units get which schedules.

The Host Management Interface 32, housed on the in-house terminals of the Host Local Intranet 30 is controlled by the Host and access by the customer is not permitted. The Host Management Interface 32 manages the Database 40 and server programs 42, 44 and 48 which connect the Database 40 to the outside portions of the systems, such as, the Customer PCs, the Display Units, and the various predefined plurality of E-mail Boxes 24, 26, and 28 (see FIG. 1). Management by the Host through the Host Management Interface 32 is defined as maintenance to the Database 40 as well as any necessary changes that are needed for E-mail Boxes 24, 26, and 28 and the Web Page 50.

As shown in FIG. 2, the Database Backup 34 is contained on the Host Management Intranet 30. Access by the customers to the Database Backup 34 is not permitted, but is the responsibility of the Host. Preferably, Server 36 and Redundant Server 38 are backed-up at least daily via a specialized program running on the Host Local Intranet 30. Of course, nothing herein limits the frequency of the backup routine and it certainly could be effected more than once a day if so desired by the Host.

With reference to FIG. 1, E-mail Boxes 24, 26, and 28 can be located on any ISP (Internet Service Provider) that is “in-house” or “off-site”. Each Display Unit E-Mail Box 24 is given a unique password and assigned (associated with) a particular Display Unit. Accordingly, if there are, for example, two hundred and twenty-seven (227) Display Units within the Intelligent Messaging System, then there would be two hundred and twenty-seven (227) Display Unit E-Mail Boxes 24. The unique “address” of the E-mail Box 24 is listed within the configuration file of the particular Display Unit to which it is assigned. Data relating to the Display Unit E-Mail Boxes 24 is controlled by the E-Mail Format Program 42 running on Server 36 and Redundant Server 38.

The Display Unit Status E-mail Boxes 26 can also be located on any ISP that is “in-house” or “off-site”. These E-Mail Boxes 26 collect status reports from the Display Unit Controllers when the Controllers “call” in for messages. These status reports include information relating to the playlists that were displayed and the start and stop time for each playlist. This provides verification to the customer that their playlist and schedules actually ran. It also notifies the customer to any potential problems with a particular Display Unit under a customer's control, such as a power outage or that the Display Unit Controller was reset. The collected status reports are sorted by the Display Unit Status Handling Program 44 running on Server 36 and Redundant Server 38 and sent to the appropriate client, preferably by e-mail. If no status is reported for a particular Display Unit, it is flagged as “non-operational”.

Configuration Files for the Display Units are created by the Configuration File Program 48 running on Server 36 and Redundant Server 38. These configuration files are placed into the Configuration File E-Mail Boxes 28 and contain the data by which each Display Unit is to operate. These files are typically created daily, however, they could be created more or less frequently depending on a particular need. When a Display Unit Controller “calls-in”, it makes connection to Configuration File E-Mail Boxes 28 to retrieve its configuration file.

The Internet Interface 54 may be in any known form, including, but not limited to, dial-up connections, cable modems, DSL lines, satellite signals and T1 and T2 lines.

Firewall 52 is provided to place a barrier between Server 36 and Redundant Server 38 and Internet Interface 54 so that unauthorized users do not access Server 36 and Redundant Server 38 and damage or corrupt any data therewithin. In the preferred embodiment, a specialized proprietary firewall is employed, however, nothing herein limits the use of any known prior art firewall.

Server 36 is the center of the Intelligent Messaging System of the present Invention. As shown in FIG. 1, it contains the Database 40, the E-Mail Format Program 42, the Display Status Handling Program 44, the Stratum3 NTP Time Server 46, the Configuration File Program 48 and the Web page 50. It also contains, although not shown, redundant hard drives (preferably “hot-swap” drives), CR-ROM or other backup medium and a backup program which communicates with the Database Backup 34 on the Host Local Intranet 30. In the preferred embodiment, the Server has a Linux® operating system, although nothing herein limits the use of other known operating systems. Server 36 interfaces with both the Internet 10 and the Host Local Intranet 30 for access by the Host.

Redundant Server 38 operates along with Server 36 in case of failure of Server 36. Its architecture and configuration is identical to Server 36 and is kept updated at all times. Redundant Server 38 also provides load sharing and balancing for Server 36.

Database 40 retains all information on each customer and their respective assigned Display Units. This information includes the Display Unit type, size and location. It also contains information that is needed to set up the configuration files which in turn sets up the operating parameters for each Display Unit. Further, Database 40 retains message frame, playlist and schedule information. Still further, it contains information relating to any master-slave configurations (in a multiple sign configuration) whether there is a temperature probe and the mode of communication.

The E-Mail Format Program 42 running on Server 36 and Redundant Server 38 interfaces the information inputted by the customer via the Web page 50. Program 42 takes the information from the Database 40 as well as the Display Unit type and formats the information into an XML data format to fit the Display Units. After the information has been formatted, it is sent to the appropriate Display Unit E-Mail Box 24 to be retrieved at a later time by the Display Unit Controller for display. Once the Display Unit Controller makes connection with its respective Display Unit E-Mail Box 24, it remains connected thereto for a time period to ensure that the full message has been is retrieved and processed by the Controller. The E-Mail Format Program 42 periodically removes old messages stored in the Display Unit E-Mail Box 24 so that only the latest messages remain within the E-Mail Box 24.

Th Display Status Handling Program 44 running on Server 36 and Redundant Server 38 provides an interface between the Display Unit Status E-Mail Boxes 26 and the reports to the customer (these reports being deliverable in a variety of manners.) At a Host predetermined time, Program 44 collects all of the information from all of the Display Unit Status E-mail Boxes 26 and sorts the information by customer (each customer having a unique ID). Each customer's data is sorted providing a list of playlists with start and stop times, any “out-of-service” time and Display Unit Controller status. This is where a customer would receive a “flag” report that a particular Display Unit was non-operational during some given time.

The Stratum3 NTP Time Server 46 is employed as the Network Time Protocol (NTP) for the Intelligent Messaging System of the present invention and runs on Server 36 and Redundant Server 38. As well known, the NTP is used to synchronize the time of a computer client or server to another server or reference time source to a primary server synchronized to Coordinated Universal Time (UTC). The Stratum3 NTP Time Server 46 operates as a client to at least two Stratum2 NTP time servers, thereby defining it as a Stratum3 server. The Host system periodically contacts the Stratum2 servers to synchronize its internal clocks to its own. A customer PC or a Display Unit Controller may get the time from the Stratum3 NTP Time Server and thereby synchronize its own internal clock to within a few hundred milliseconds of UTC.

The Configuration File Program 48 running on Server 36 and Redundant Server 38 updates the configuration files for each Display Unit Controller at least every twenty-four (24) hours in the preferred embodiment. Of course, the update could be performed more or less often if so desired. Nothing within the system of the present invention limits when the Controller configuration file can be updated. These configuration file updates are performed so that any changes that may have been inputted by the customer for one or more Display Units is effected. Program 48 creates new updated configuration files, erases old configuration files in the Configuration E-Mail Boxes 28 and “writes” new configuration files to the appropriate Configuration E-Mail Box 28 associated with the a particular Display Unit which has been programmed for a change by the customer. This protocol permits the “re-configure” command to be sent to the Display Unit Controller by e-mail.

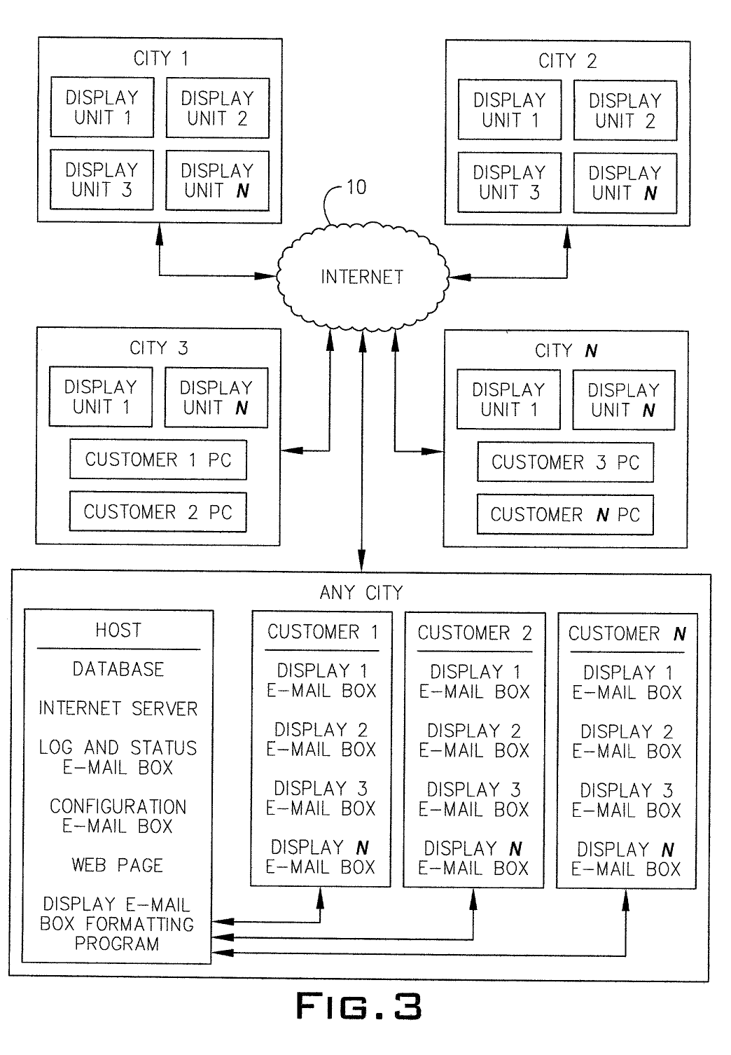

Referring to FIG. 3, a flow diagram is shown illustrating a configuration of the Intelligent Messaging System of the present invention. It is important to note that FIG. 3 is merely an illustration of the system and is not meant to limit the scope of the invention herein. As shown, various elements of the system are located in a variety of locations (in this example a plurality of cities) and are connected by the Internet 10. In this example, City 1, City 2, City 3, Any City and City N are provided, wherein N is an infinite number. As further shown, City 1 and City 2 each have a plurality of Display Units employed therein, wherein Display Unit N for each city represents an infinite number of Display Units. Even though both City 1 and City 2 have a Display Unit designated as 1, 2 and 3, it is understood that these Display Units are separate and distinct from one another. As previously set forth, each Display Unit within the system has its own unique identifier or address. As it can be seen, there is no need for a customer to be located in City 1 or City 2, nor a need for the Host or any of the ISPs which may service the Display Unit E-Mail Boxes 24 to be located within the boundaries of City 1 or City 2. As further shown, City 3 is provided with Display Unit 1 and Display Unit N as well as Customer 1 PC and Customer 2 PC, wherein again, N represents an infinite number of Display Units. It is important to note that Customer 1 and Customer 2 are not bound to utilize the Display Units within City 3. FIG. 3 merely illustrates that Customer 1 and Customer 2 are located within City 3. They may have access to Display Units within City 1, 2, 3 or N, wherein City N represents an infinite number of cities or locations. As even further shown, City N has Display Unit 1 and Display Unit N and Customer 3 and Customer N located therewithin, wherein again N represents an infinite number.

With continuing reference to FIG. 3, it is shown that the Host of the Intelligent Messaging System is located in Any City. For mere illustration, it is shown that the ISPs for Customer 1, Customer 2 and Customer N, and therefore their mailboxes, are all located in Any City. All of this is made possible, since two-way communication is effected through the Internet. An infinite number of possibilities for configuration of the system could be employed for the Intelligent Messaging System of the present invention due to Internet communications. As an example, Customer 1 located in City 3 could be utilizing Display Unit 1 and Display Unit 2 in City 1 and Display Unit 1 in City 3 all the while communicating with the Host and an ISP through the Internet 10 in Any City.

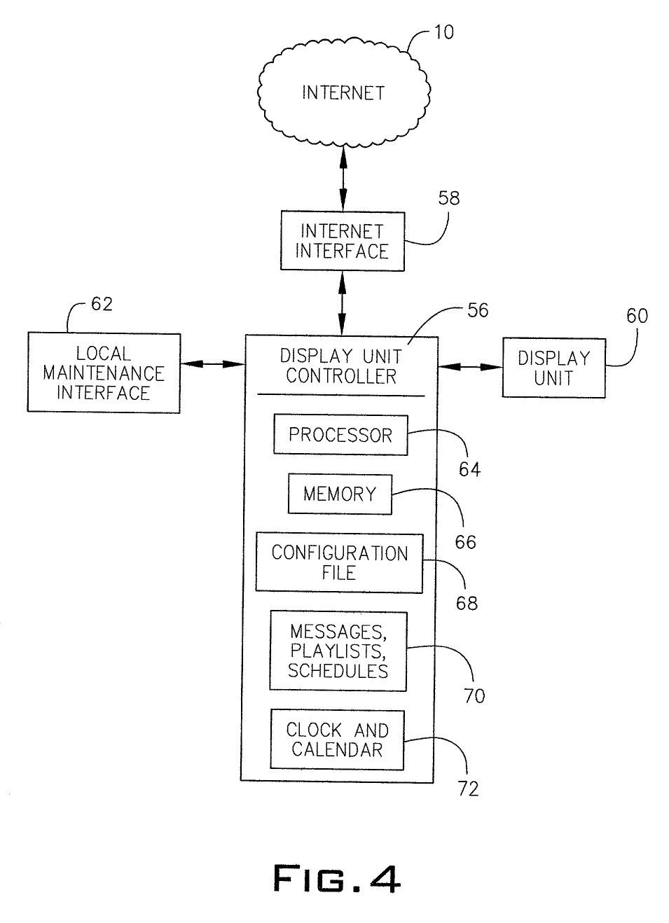

To illustrate more effectively how a Display Unit Controller is configured in relation to a Display Unit and how it makes contact with the Host Server, reference is made to FIG. 4. As shown, the Internet 10 connects to a Display Unit Controller 56 through an Internet Interface 58. Preferably, this connection is made by way of modem, such as a CDMA wireless modem, a CDPD wireless modem, or a hardwired modem. Of course other means of known connectivity could be employed if desired. Controller 56 detects which type of modem, or connection, it has when power is applied thereto. At that time, the proper communication protocol is established and configured for Controller 56.

With continuing reference to FIG. 4, it is shown that Controller 56 is connected to a Display Unit 60. As previously set forth, in the preferred embodiment, Display Unit 60 is an LED display. The display type may be single, multi or full colored. The size of Display Unit 60 and its pixel height and width varies depending on the need of the customer and that which Controller 56 can support. In the preferred embodiment, Display Unit 56 uses a latched or a scanning method of operation.

Also shown in FIG. 4, is a Local Maintenance Interface 62 which in the preferred embodiment is a serial port of Controller 56. Local Maintenance Interface 62 is used to connect to a PC or like computing device so that maintenance (i.e., troubleshooting) can be performed upon Controller 56 and/or Display 60.

Controller 56 is made up of a processor 64, memory 66, a configuration file 68, messages, playlists and schedules 70, a clock and calendar 72 as well as EPROM (not shown) and a set of I/O ports (also not shown) for Display Unit 60. Memory 66 is divided into two main parts: 1) flash memory which contains the operating code; and 2) static memory which holds the configuration file 68, messages, playlists and schedules 70, as well as log events and Controller status. The Configuration File 68 is loaded into memory 66 when it is retrieved from the Configuration File E-Mail Box 28 and sets the operating conditions and parameters by which Controller 56 operates. Messages, playlists and schedules 70 are retrieved from its assigned Display Unit E-Mail Box 24 at a time set by the Configuration File 68 and stored in the static memory of Controller 56. The clock and calendar are set by interfacing with the Stratum3 NTP Time Server 46 on Server 36 and is used by Controller 56 to start and stop the playlists at the customer programmed scheduled times.

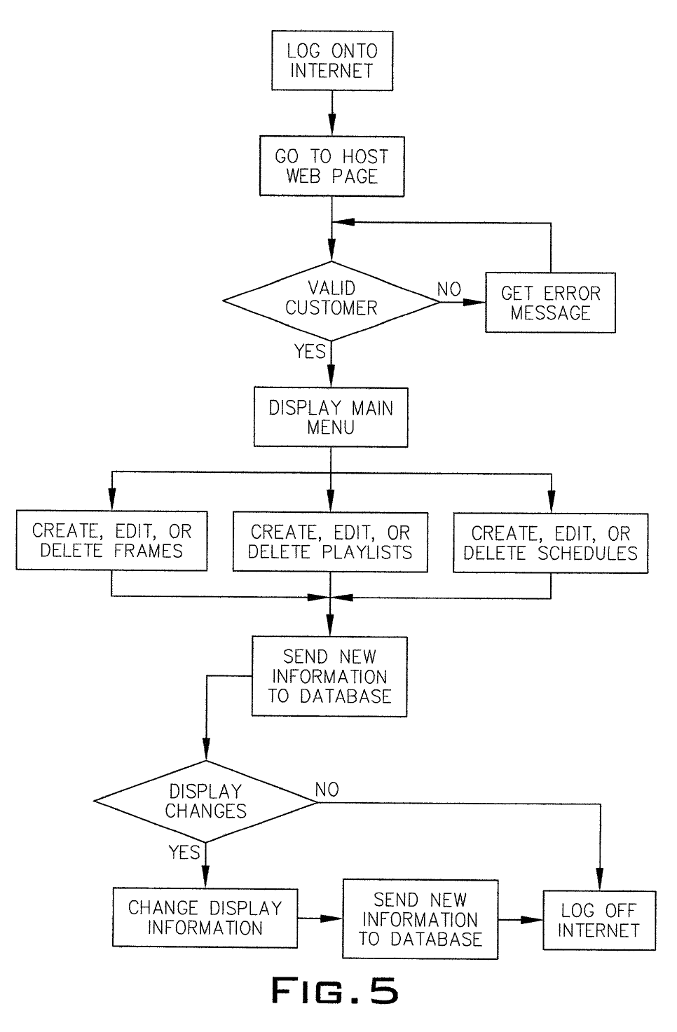

Referring now to FIG. 5, a flow diagram is shown illustrating how a customer, utilizing the Intelligent Messaging System of the present invention, interfaces with the Host Server via a PC to program content for display upon Display Units assigned to the particular customer. In doing so, the customer logs on to the Internet utilizing any of the known Internet interface protocols employing a PC or like computing device. The customer directs their Internet connection to the Host Web Page 50 that is maintained on the Host Server 36 (see FIG. 2). The Web Page requests a user name and password to validate the customer. If the customer user name and password are not valid, the Web Page returns an error message and re-asks for a valid user name and password. Upon inputting a valid user name and password, the Web Page displays a main menu. From the main menu, the customer is given access to create, edit and/or delete frames (thereby creating content or messages for display), create, edit and/or delete playlists and create, edit and/or delete schedules. It is understood that access is granted to the customer to each and every Display Unit that has been assigned to the customer regardless of the location of any particular Display Unit within the system. Once the customer is satisfied with the frames (messages), playlists and schedules that have been programmed, the information is sent to the Database 40 on Server 36 for later delivery to the appropriate Display Unit E-Mail Box 24. Next a query is asked whether the customer wishes to make any changes to the Display Units under their assignment. If the answer is “no”, then the customer simply logs off the Web Page and the Internet. However, if the answer to the question is “yes”, then the customer is given the ability, on a menu page on the Web site, to make certain changes to the Display Units including, Display Unit location changes, Display Unit communication changes (i.e., which e-mail box to call, what time to call-in to its assigned e-mail box, time to leave log and status data, Display Unit dim and bright times and Display Unit turn-on and turn-off times. Once the customer is satisfied with these change, the information is sent to the Database 40 for later delivery to the appropriate Configuration File E-Mail Box 28. Thereafter, the customer simply logs off the Web Page and the Internet.

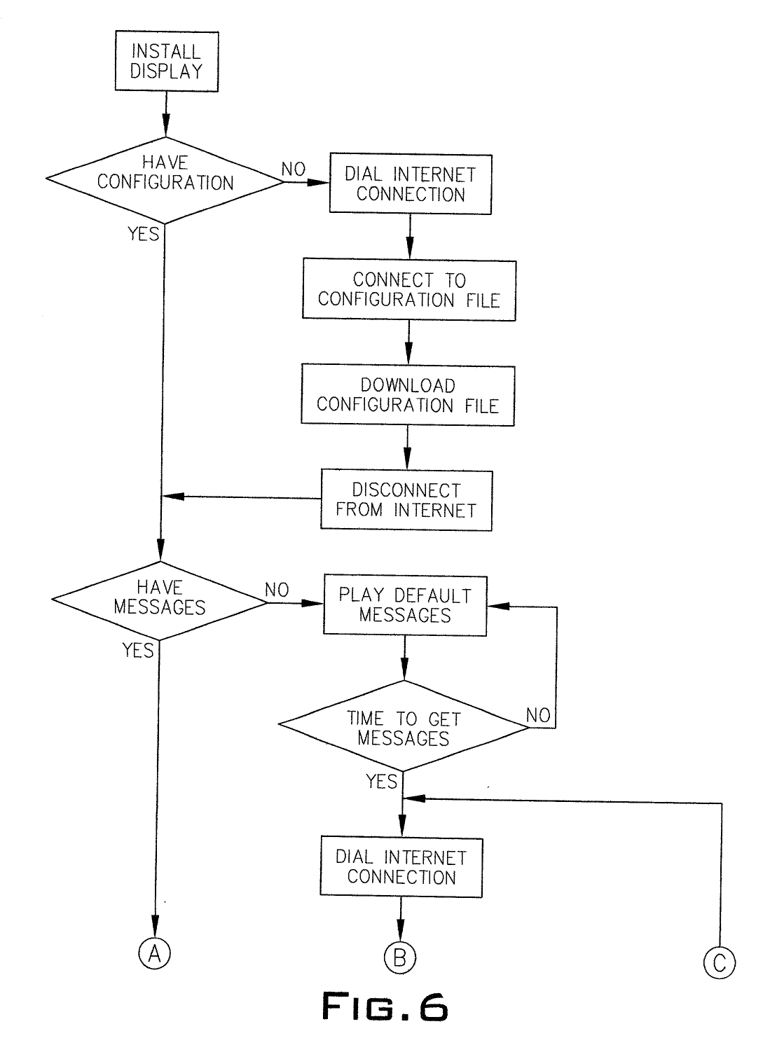

Referring now to FIGS. 6-8, a flow diagram is provided illustrating the operation of a Display Unit and its associated Controller utilized within the Intelligent Messaging System of the present invention, including how the Controller retrieves content (messages) for display upon a Display Unit.

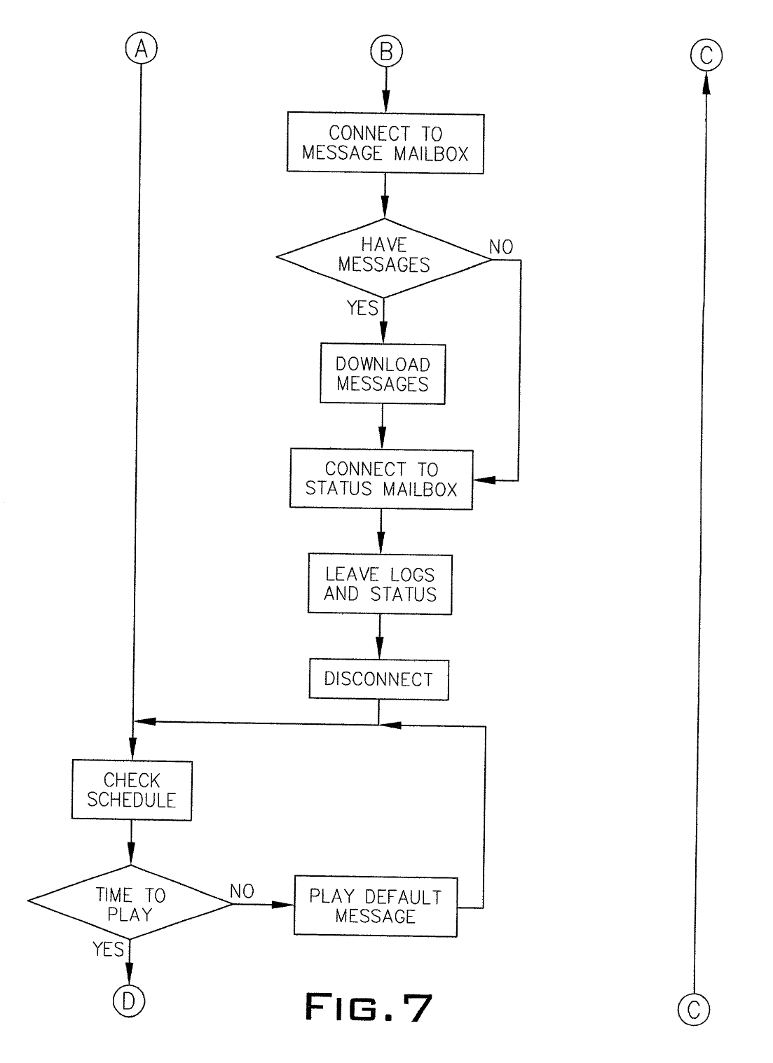

As first shown in FIG. 6, it is understood that a Display Unit is installed. As previously set forth, an infinite number of Display Units can be installed in an infinite number of locations. Once the Display Unit is installed and is given electrical power, a query is asked whether the Controller, and hence the Display Unit, is configured (does it have its configuration file)? If the answer is “no”, then the Controller dials into and connects to the Internet. Connection is made to the appropriate, pre-assigned Configuration File E-Mail Box, whereby the Controller downloads its configuration file and disconnects from the Internet. If the answer to the question is “yes”, no dial-up to the Internet is effected. Instead, a query is made whether the Controller has any messages to display (as shown in FIG. 6, this is the same point that the Display Unit operational scheme would find itself after downloading the configuration file). If the answer is “no”, then the Controller instructs the Display Unit to play the default message (which could be nothing or an advertisement for the Host, for example). While the default message is being played, a query is made whether it is time get messages (this time is set by the configuration file previously downloaded into the Controller). If the answer to this question is “no”, then the Display Unit is instructed to continue to play the default message until another query is made regarding whether it is time to get messages. This loop will continue until a “yes” is provided to the query that it is time to get messages. Returning to the query whether the Controller has any messages to display, if th answer is “yes”, then the Controller checks the schedule (follow the encircled capital letter A on FIG. 6 to the encircled capital letter A on FIG. 7).

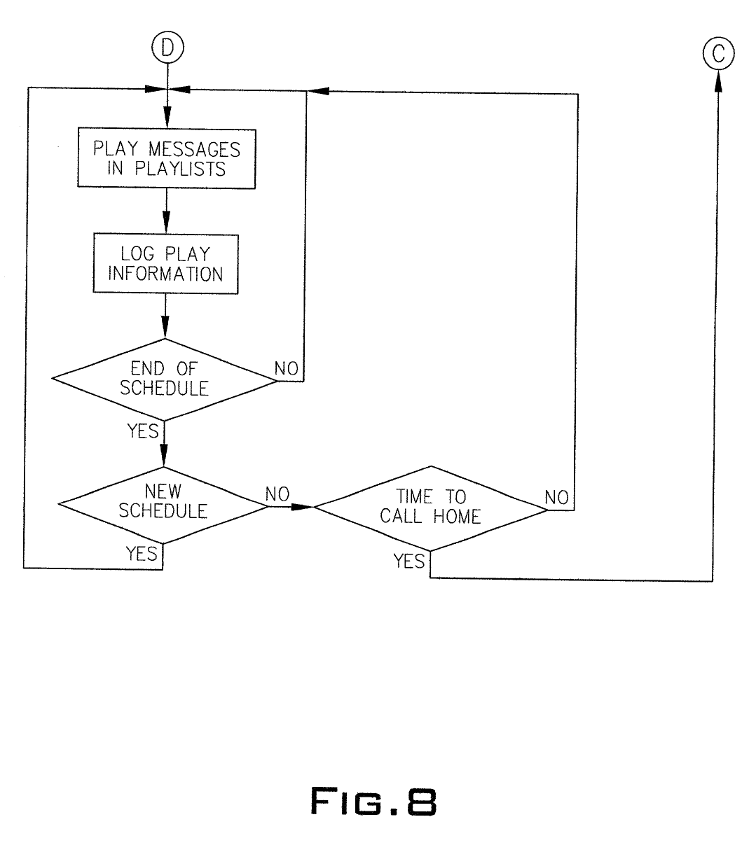

With reference to FIG. 7, once the schedule is checked, within the memory of the Controller (which has been downloaded through the configuration file), a query is made whether it is time to play the messages. If the answer is “no”, then a default message is played and the schedule is re-checked (looped) until the answer to the query is “yes”. At this point (by following the encircled capital letter D on FIG. 7 to the encircled capital letter D on FIG. 8), the messages of the playlists, previously downloaded, are displayed. Thereafter, the play information is logged into memory of the Controller. Next a query is made whether the schedule is at its end. If the answer is “no”, then the Controller continues to the play the messages of the playlist as shown in FIG. 8. If the answer to the query of whether the schedule is at its end is “yes”, then a query is made whether any new schedules are loaded. If the answer to this question is “yes”, then the Controller instructs the Display unit to the play the appropriate messages from the playlist, log the play information in memory and query the system regarding end of schedule as shown in FIG. 8.

If the answer to the query of whether there is a new schedule is “no”, as shown on the bottom of FIG. 8, another query is made whether it is time to call home. If the answer to this question is “no”, then the system loops through the playing of messages from the playlist as previously described hereinabove and shown in FIG. 8. However, if the answer to time to call home is “yes”, then the Controller connects to the Internet by dialing-in (by following the encircled capital letter C near the top of on FIG. 8 to the encircled capital letter C near the bottom of FIG. 7, and by continuing to follow the encircled capital letter C near the top of FIG. 7 to the encircled capital letter C on the bottom of FIG. 6).

Once the Internet connection is made, contact is made with the appropriate pre-assigned Display Unit E-Mail Box wherein messages for display upon a particular Display Unit are stored (follow encircled capital letter B near the bottom FIG. 6 to encircled capital letter B on the top of FIG. 7. Once contact with the mail box is made, a query is asked whether it contains any messages. If the answer is “no”, then connection is made to the appropriate pre-assigned Display Unit Status E-Mail Box and the collected logs and status reports within the memory of the Controller of the particular Display Unit are left therewithin. Thereafter, the Controller disconnects from the Internet.

With continuing reference to FIG. 7, if the answer to the query of whether there are any messages in the mail box is “yes”, then the messages are downloaded into the memory of the Display Unit Controller. Thereafter, connection is made to the Display Unit Status E-Mail Box and the collected logs and status reports within the memory of the Controller of the particular Display Unit are left therewithin. Then, the Controller disconnects from the Internet. At this point, with the Controller having retrieved its needed information to play a message on its respective Display Unit, its schedule is checked as shown in FIG. 7. Thereafter, the system continues to operate in accordance with the flow diagram of FIGS. 6-8 which has now been fully described.

It is understood that many of the aforementioned steps can be performed in a varying order as that which has been described above and thereby still achieve the same result. However, the above set forth steps does represent the preferred embodiment.

Equivalent elements can be substituted for the ones set forth above such that they perform the same function in the same way for achieving the same result. Further, equivalent steps can be substituted for the ones set forth above to operate the system of the present invention in the same manner thereby achieving the same result and function.

Having thus described the invention what is claimed and desired to be secured by letters patent is:

1. A remotely programmable message display system comprising:
a) a host computer server having an operating system, an information database, an e-mail formatting software program, a display unit status handling software program and a dynamic content web page,
b) a first Internet interface coupled to the host computer server for establishing a bi-lateral communication link with the Internet,
c) at least one message display unit having a controller and a second Internet interface coupled thereto, the controller intermediately coupled between the display unit and the second Internet interface, the second Internet interface for establishing a bi-lateral communication link with the Internet,
d) at least one computer connectable to the Internet and operated by a customer desirable of programming messages for display upon the at least one message display unit, the customer having access to the host computer server information database by establishing a communication link between the at least one computer and the host server dynamic content web page through the Internet,
e) at least one display unit message e-mail box located on an Internet service provider computer server for receiving and retaining the messages programmed by the customer for display upon the at least one message display unit, the messages deposited in the at least one display unit message e-mail box by the host server e-mail formatting software program which interfaces with the host server information database after the customer has programmed the messages on the host server dynamic content web page, the display unit controller retrieving the messages from the at least one display unit message e-mail box at a predetermined time, and
f) at least one display unit status e-mail box located on an Internet service provider computer server for receiving message logs and display unit status data from the controller of the at least one display unit, the host server display status handling software program retrieving the logs and status data from the at least one display unit status e-mail box for delivery to the customer in the form of a report.

2. The remotely programmable message display system of claim 1, further comprising:
a) the host server having a display unit controller configuration file software program, and
b) at least one configuration file e-mail box located on a Internet service provider computer server for receiving and retaining display unit controller configuration file data deposited in the at least one configuration file e-mail box by the host server display unit controller configuration file software program which interfaces with the host server information database after the customer has programmed the configuration file data on the host server dynamic content web page, the display unit controller retrieving the configuration file data from the at least one configuration file e-mail box at a predetermined time.

3. The remotely programmable message display system of claim 2, wherein the configuration file data includes display unit location changes, addresses of e-mail boxes that the display unit controller should call, times that the display unit controller should call-in to its assigned e-mail boxes, display unit dim and bright times and display unit turn-on and turn-off times.

4. The remotely programmable message display system of claim 1, further comprising a host local intranet having a management interface software program and a database backup, the host local intranet interfacing with the host computer server.

5. The remotely programmable message display system of claim 1, further comprising at least one host computer redundant server configured as a mirror image of the host computer server.

6. The remotely programmable message display system of claim 1, further comprising a firewall coupled between the host computer server and the first Internet interface.

7. The remotely programmable message display system of claim 5, further comprising a firewall coupled between the host computer server and at least one host computer redundant server and the first Internet interface.

8. The remotely programmable message display system of claim 1, wherein the at least one message display unit is an LED sign board.

9. The remotely programmable message display system of claim 1, wherein the controller comprises a processor, memory and a clock and calendar.

10. The remotely programmable message display system of claim 1, wherein the host computer server includes an Internet network protocol time server.

11. The remotely programmable message display system of claim 1, wherein the messages programmed by the customer which are deposited into the at least one message e-mail box include data relative to frames to be displayed on the at least one display unit, playlists of frames representing an order of display and schedules representing the actual start and stop time for each playlist.

12. A remotely programmable message display system comprising:
a) a host computer server having an operating system, an information database, an e-mail formatting software program, a display unit status handling software program, a display unit controller configuration file software program and a dynamic content web page,
b) a first Internet interface coupled to the host computer server for establishing a bi-lateral communication link with the Internet,
c) a plurality of message display units, each display unit having a controller and an Internet interface coupled thereto, the controller intermediately coupled between the display unit and the Internet interface, the Internet interface of each display unit establishing a bi-lateral communication link with the Internet for each display unit, each display unit having a unique identifier,
d) a plurality of computers, each connectable to the Internet and operated by a customer desirable of programming messages for display upon at least one of the plurality of message display units, each customer having a unique identifier for permitting access to the host computer server information database, each customer associated with at least one of the plurality of computers for establishing a communication link with the host server dynamic content web page through the Internet,
e) a plurality of display unit message e-mail boxes located on at least one Internet service provider computer server for receiving and retaining the messages programmed by each customer for display upon the plurality of message display units, the messages deposited in the plurality of display unit message e-mail boxes by the host server e-mail formatting software program which interfaces with the host server information database after each customer has programmed their respective messages on the host server dynamic content web page, each display unit controller retrieving messages at a predetermined time from one of the plurality of display unit message e-mail boxes which has been preassigned to be associated with a particular display unit of the plurality of display units, each display unit e-mail box having a unique address,
f) at least one display unit status e-mail box located on an Internet service provider computer server for receiving message logs and display unit status data from all of the controllers of the plurality of display units, the host server display status handling software program retrieving the logs and status data from the at least one display unit status e-mail box for delivery to each customer in the form of a report wherein each customer receives a report for each display unit assigned to each customer, and
g) a plurality of configuration file e-mail boxes located on at least one Internet service provider computer server for receiving and retaining display unit controller configuration file data deposited in the plurality of configuration file e-mail boxes by the host server display unit controller configuration file software program which interfaces with the host server information database after each customer has programmed the configuration file data for each display unit assigned thereto on the host server dynamic content web page, each display unit controller retrieving the configuration file data at a predetermined time from one of the plurality of configuration file e-mail boxes which has been preassigned to be associated with a particular display unit of the plurality of display units.

13. The remotely programmable message display system of claim 12, further comprising a host local intranet having a management interface software program and a database backup, the host local intranet interfacing with the host computer server.

14. The remotely programmable message display system of claim 12, further comprising at least one host computer redundant server configured as a mirror image of the host computer server.

15. The remotely programmable message display system of claim 12, further comprising a firewall coupled between the host computer server and the first Internet interface.

16. The remotely programmable message display system of claim 12, wherein the host computer server includes an Internet network protocol time server.

17. The remotely programmable message display system of claim 12, wherein the controller comprises a processor, memory and a clock and calendar.

18. The remotely programmable message display system of claim 17, wherein the display unit controller configuration file data for a particular display unit of the plurality of display units retrieved from the preassigned configuration file e-mail box for the particular display unit is stored into memory of the controller.

19. The remotely programmable message display system of claim 12, wherein the messages programmed by each customer which are deposited into the plurality of message e-mail boxes include data relative to frames to be displayed on display units assigned to each customer from the plurality of message display unit, playlists of frames representing an order of display and schedules representing the actual start and stop time for each playlist.

20. The remotely programmable message display system of claim 12, wherein the number of display units of the plurality of message display units is equal to the number of display unit e-mail boxes, and each display unit is assigned to its own separate display unit e-mail box.

21. The remotely programmable message display system of claim 12, wherein the number of display units of the plurality of message display units is equal to the number of configuration file e-mail boxes, and each display unit is assigned to its own configuration file e-mail box.

22. A method of programming an electronic message display unit through the Internet, the message display unit displaying graphic illustrations from a light source connected to the display unit, the display unit having an Internet interface for permitting bi-lateral communication through the Internet and a controller, the steps of the method comprising:
a) providing a host computer server having an information database, an e-mail formatting software program, a display unit status handling software program and a dynamic content web page,
b) providing an Internet interface coupled to the host computer server for permitting the host computer server to bi-laterally communicate with the Internet,
c) providing a display unit e-mail box on an Internet service provider computer server for receiving and retaining messages representing the graphic illustrations for display upon the electronic message display unit,
d) providing a display unit status e-mail box on an Internet service provider computer server for receiving log and status data relative to the electronic message display unit,
e) providing a computing device connectable to the Internet for communicating with the host computer server information database through the dynamic content web page,
f) logging onto the dynamic content web page with the computing device by entering at least one unique identifier,
g) creating a message to be displayed on the electronic message display unit by inputting content into the host computer server information database,
h) formatting the inputted content representing the created message in the host computer server information database by the host server e-mail formatting software program,
i) delivering the created message to the display unit e-mail box through the Internet,
j) contacting the display unit e-mail box though the Internet so that the display unit controller can retrieve the created message,
l) contacting the display unit status e-mail box through the Internet so that the display unit controller can deliver log and status data relative to the electronic message display unit,
m) displaying the created message on the electronic message display unit,
n) retrieving the log and status data relative to the electronic message display unit from the display unit status e-mail box through the Internet by the host computer server display status handling software program,
o) formatting the retrieved log and status data relative to the electronic message display by the host computer server display status handling software program, and
p) delivering the formatted retrieved log and status data relative to the electronic message display unit to a customer who created the message for display in the form of a report.

23. The method of programming an electronic message display unit according to claim 22, wherein the display unit controller includes memory having a configuration file representing operation parameters for the electronic message display unit.

24. The method of programming an electronic message display unit according to claim 23, further comprising the step of providing a configuration file e-mail box uniquely associated with the electronic message display unit.

25. The method of programming an electronic message display unit according to claim 23, wherein the configuration file can be updated periodically by delivering new configuration file data to the configuration file e-mail box and permitting the display unit controller to communicate with the configuration file e-mail box through the Internet thereby retrieving the new configuration file data retained therein.
